(19) United States
(12) Patent Application Publication
(10) Pub. No.: US 2018/0364798 A1
(43) Pub. Date: Dec. 20, 2018

(54) INTERACTIVE SESSIONS

(71) Applicant: Lenovo (Singapore) Pte. Ltd., Singapore (SG)

(72) Inventors: Timothy Winthrop Kingsbury, Cary, NC (US); Ryan Charles Knudson, Durham, NC (US); Roderick Echols, Chapel Hill, NC (US)

(21) Appl. No.: 15/625,667

(22) Filed: Jun. 16, 2017

(51) Int. Cl. G06F 3/01; G06F 3/16; G06F 9/44

(52) U.S. Cl. CPC G06F 3/01; G10L 25/78; G06F 9/4446; G06F 3/167

(57) ABSTRACT

One embodiment provides a method, including: receiving, at an information handling device, an indication to begin an interactive session associated with a first context; receiving, during the interactive session, an indication to begin at least one other interactive session, wherein the at least one other interactive session is associated with another context; and performing, without ending the interactive session, at least one output function associated with the at least one other interactive session. Other aspects are described and claimed.

### BACKGROUND

Information handling devices (“devices”), for example smart phones, tablet devices, smart speakers, laptop and personal computers, and the like, may be capable of receiving user inputs (e.g., user queries, user commands, etc.) and providing outputs responsive to the inputs. The receipt of input and provision of output may be handled by a personal digital assistant disposed on the device. Situations occur where a user provides multiple user inputs to a digital assistant within a short period of time, where each of the user inputs is associated with a different context or user intent.

### BRIEF SUMMARY

In summary, one aspect provides a method, comprising: receiving, at an information handling device, an indication to begin an interactive session associated with a first context; receiving, during the interactive session, an indication to begin at least one other interactive session, wherein the at least one other interactive session is associated with another context; and performing, without ending the interactive session, at least one output function associated with the at least one other interactive session.

Another aspect provides an information handling device, comprising: at least one processor; a memory device that stores instructions executable by the at least one processor to: receive an indication to begin an interactive session associated with a first context; receive, during the interactive session, an indication to begin at least one other interactive session, wherein the at least one other interactive session is associated with another context; and perform, without ending the interactive session, at least one output function associated with the at least one other interactive session.

A further aspect provides a product, comprising: a storage device that stores code, the code being executable by a processor and comprising: code that receives an indication to begin an interactive session associated with a first context; code that receives, during the interactive session, an indication to begin at least one other interactive session, wherein the at least one other interactive session is associated with another context; and code that performs, without ending the interactive session, at least one output function associated with the at least one other interactive session.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of performing at least one output function associated with one of at least two active interactive sessions.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital assistant software employed on the device (e.g., Siri® for Apple®, Cortana® for Windows®, Alexa® for Amazon®, etc.). Digital assistants are able to provide outputs (e.g., audible outputs, visual outputs, etc.) that are responsive to a variety of different types of user inputs (e.g., voice inputs, etc.).

Conventionally, digital assistants may support two types of user conversations: single-turn conversations and multi-turn conversations. A single turn conversation can be processed with exactly one request from the user. For example, a user may provide the audible input command, “dim the lights”. Responsive to receiving this command, a digital assistant may perform a corresponding function (e.g., the digital assistant may dim the lights in the room, provide an audible confirmation output such as “okay”, a combination thereof, etc.). A multi-turn conversation requests additional input from the user to construct a fully formulated request. For example, a user may command a digital assistant to order a pizza. Responsive to receiving this command, the digital assistant may ask the user a series of successive questions that require additional user input (e.g., “where did you want to order the pizza from?”, “what size pizza did you want to order?”, “what kinds of toppings do you want on your pizza?”, etc.).

Once a multi-turn conversation has been started with a digital assistant, it is not possible to interrupt the conversation (e.g., to provide input associated with a different context or a different intent, etc.) and then return to a previous conversation or move to a different conversation. For example, a user may first provide the audible input command “order a pizza” to which the digital assistant responds with the audible output “okay, which toppings would you like on your pizza?” The user may then provide the command “dim the lights” to which the digital assistant responds with the audible output “I do not recognize that topping”. Existing digital assistants are unable to handle the context switch that would be required to process the command “dim the lights” while processing a pizza order.

Accordingly, an embodiment provides a method for performing at least one output function associated with one of at least two active interactive sessions, where each of the at least two active interactive sessions are associated with a different context or intent. In an embodiment, an indication to begin an interactive session associated with a first context or intent may be received at a device. The interactive session may comprise the receipt of at least one user input (e.g., a user query, a user command, a user statement, etc.) and the provision of at least one output function (e.g., a responsive output, performance of a corresponding function, etc.). An embodiment may then receive an indication to begin at least one other interactive session associated with another context. An embodiment may then perform at least one output function associated with the at least one other interactive session without ending the original, or previous, interactive session(s). Such a method may enable digital assistants to process multiple commands associated with different contexts more efficiently.

The illustrated example embodiments will be best understood by reference to the figures. The following description is intended only by way of example, and simply illustrates certain example embodiments.

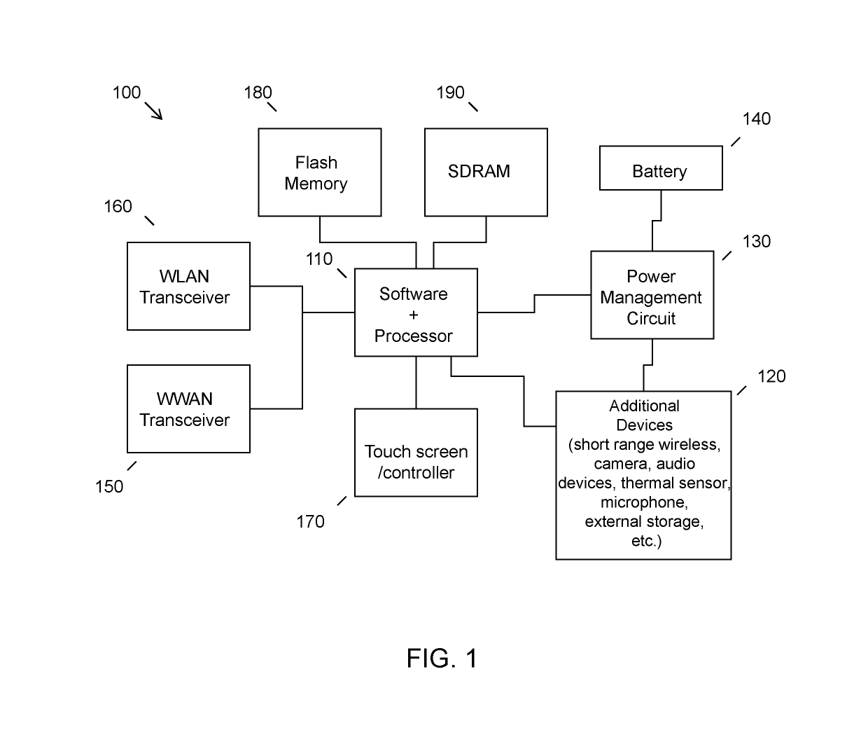

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes a touch screen 170 for data input and display/rendering. System 100 also typically includes various memory devices, for example flash memory 180 and SDRAM 190.

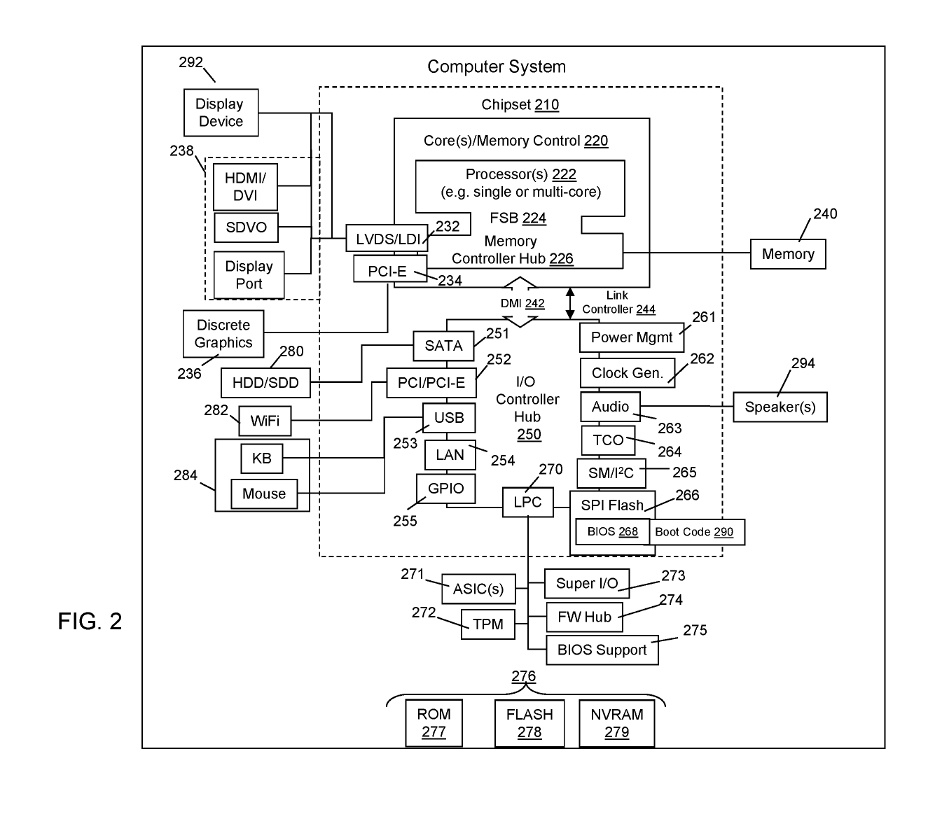

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

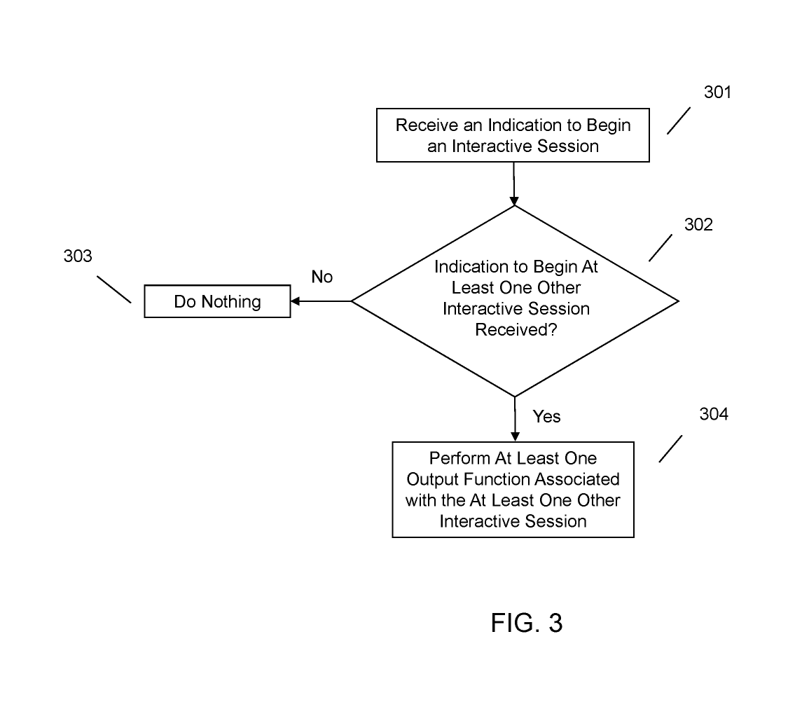

Referring now to FIG. 3, an embodiment may identify an interactive session associated with received user input and subsequently perform a corresponding function associated the context of the identified interactive session. At 301, an embodiment may receive an indication to begin an interactive session associated with a first context. An interactive session may be defined as a session with a digital assistant or other interactive application in which a user provides input, the digital assistant processes or analyzes the input, and the digital assistant then provides an output responsive to the input. An interactive session may include a single exchange of input and output, referred to herein as a single-turn interactive session, or multiple exchanges of input and output, referred to herein as a multi-turn interactive session.

In an embodiment, the indication to begin an interactive session may be associated with user-provided input. In an embodiment, the user-provided input indication may be a wakeup action provided by a user (e.g., one or more wakeup words, a depression of a button for a predetermined length of time, a selection of a digital assistant icon, etc.). In an embodiment, the wakeup action may be provided prior to or in conjunction with user input. For example, a user may provide the vocal input, “Ok Surlexana, order a pizza.” In this scenario, “Ok Surlexana” is the wakeup word and upon identification of the wakeup word an embodiment may prime the system to listen for additional user input. Responsive to the identification of the wakeup action, an embodiment may initiate an interactive session. In another embodiment, the indication may not be associated with a wakeup action. For example, the system may simply “listen” to the user and determine when the user is providing input directed at the system. The interactive session may then be initiated when the system determines that the user input is directed to the system.

In an embodiment, the interactive session may comprise the receipt of at least one user input and the performance of at least one output function responsive to the at least one user input. In an embodiment, the interactive session may be associated with a single-turn conversation (i.e., the provision of a single output responsive to a single user input) or a multi-turn conversation (i.e., the provision of multiple outputs responsive to the receipt of multiple inputs). In an embodiment, the interactive session may be associated with a particular context or user intent. The context of the interactive session may be determined by the user input. For example, responsive to receiving a user command to dim the lights, the context associated with the interactive session may be a light-dimming context. In an embodiment, the interactive session may be associated with a single context.

During the interactive session, an embodiment may receive user input (e.g., voice input, touch input, etc.) including or associated with a user query or a user command at a device (e.g., smart phone, smart speaker, tablet, laptop computer, etc.). In an embodiment, the device may employ digital assistant software capable of receiving and processing user input and subsequently providing output (e.g., audible output, textual output, visual output, etc.) corresponding or responsive to the user input. In an embodiment, the user input may be any input that requests the digital assistant to provide a response. For example, the user may ask the digital assistant a general question about a topic, the user may ask the digital assistant to provide instructions to assemble an object, the user may ask the digital assistant's opinion on a topic, the user may make a statement which allows a response, and the like.

The input may be received at an input device (e.g., physical keyboard, on-screen keyboard, audio capture device, image capture device, video capture device, etc.) and may be provided by any known method of providing input to an electronic device (e.g., touch input, text input, voice input, etc.). For simplicity purposes, the majority of the discussion herein will involve voice input that may be received at an input device (e.g., a microphone, a speech capture device, etc.) operatively coupled to a speech recognition device. However, it should be understood that generally any form of user input may be utilized.

In an embodiment, the input device may be an input device integral to the speech recognition device. For example, a smart phone may be disposed with a microphone capable of receiving voice input data. Alternatively, the input device may be disposed on another device and may transmit received voice input data to the speech recognition device. For example, voice input may be received at a smart speaker that may subsequently transmit the voice data to another device (e.g., to a user's smartphone for processing, etc.). Voice input data may be communicated from other sources to the speech recognition device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the input device may be configured to continuously receive voice input data by maintaining the input device in an active state. The input device may, for example, continuously detect voice input data even when other sensors (e.g., cameras, light sensors, speakers, other microphones, etc.) associated with the speech recognition device are inactive. Alternatively, the input device may remain in an active state for a predetermined amount of time (e.g., 30 minutes, 1 hour, 2 hours, etc.). Subsequent to not receiving any voice input data during this predetermined time window, an embodiment may switch the input device to a power off state. The predetermined time window may be preconfigured by a manufacturer or, alternatively, may be configured and set by one or more users.

In an embodiment, the speech recognition device, or another device associated with the speech recognition device, may perform at least one output function responsive to the user input. In an embodiment, the output function may comprise the provision of output, the performance of a task, a combination thereof, and the like. Regarding the provision of output, the output may be audio output, visual output, a combination thereof, or the like. In an embodiment, the audible output may be provided through a speaker, another output device, and the like. In an embodiment, the visual output may be provided through a display screen, another display device, and the like. In an embodiment, the output device may be integral to the speech recognition device or may be located on another device. In the case of the latter, the output device may be connected via a wireless or wired connection to the speech recognition device. For example, a smart phone may provide instructions to provide audible output through an operatively coupled smart speaker. Regarding the performance of a task, the task may be virtually any task that is capable of being executed by one or more devices. For example, an embodiment may dim the lights in the room, change a television channel, commence a financial transaction, and the like.

At 302, an embodiment may receive an indication to begin at least one other interactive session. The indication to begin the at least one other interactive session may be received in the same way as the indication to begin the first interactive session, which is elaborated upon above. In the case that the device normally requires a wake-up word or action, the user may not have to provide this wake up action again. For example, if the user is already interacting with the digital assistant, the user may not have to provide the wake-up action. As an example, the device may provide output that requires the user to provide additional input, so the device may be “listening” to the user when the user provides the indication to begin at least one other interactive session. In other words, the indication to begin at least one other interactive session may be based upon the input that the user provides and the device determining that the input does not match the context or intent of the previously provided input or the provided output.

The at least one other interactive session may also be similar to the first interactive session (i.e., comprising at least one user input and responsive output), the specifics of which are also elaborated upon above. In an embodiment, the at least one other interactive session may be multiple interactive sessions. In an embodiment, each of the other interactive sessions may also be associated with a context, which may be different than the context of the first, or any of the other interactive sessions. For example, the first interactive session may be associated with a light-dimming context, a second interactive session may be associated with a shopping list creation context, a third interactive session may be associated with a direction provision context, etc. In an embodiment, the indication to begin the at least one other interactive session and/or the initiation of the at least one other interactive session may be received and commenced during provision of the initial interactive session.

Responsive to receiving, at 302, the indication to begin the at least one other interactive session, an embodiment may perform, at 304, at least one output function associated with the corresponding interactive session. In an embodiment, the at least one output function may also be performed during the provision of the initial, or any of the other, interactive sessions. Responsive to not receiving, at 302, an indication to begin at least one other interactive session, an embodiment may take, at 303, no further action.

In an embodiment, in a situation where multiple interactive sessions are simultaneously active, an embodiment may receive user input. An embodiment may then identify the interactive session that the user input is associated with. In an embodiment, the identification of which interactive session the user input is associated with may be conducted using a statistical weighting algorithm. For example, an embodiment may determine that the user input, “add pepperoni”, is associated with a pizza ordering context. An embodiment may then determine whether the pizza ordering context of the user input is associated with a context of any currently active interactive session. For instance, using the statistical weighting algorithm, an embodiment may conclude that the user input, “add pepperoni”, is more likely associated with an interactive session associated with a pizza ordering context than an interactive session associated with a song identification context. Responsive to identifying an interactive session associated with the user input, an embodiment may then continue the corresponding interactive session. In an embodiment, responsive to not identifying any current interactive session associated with the user input, an embodiment may initiate a new interactive session comprising the user input. In another embodiment, responsive to not identifying an associated interactive session, an embodiment may query a user to identify which session the input should be associated with, a currently active interactive session or a new interactive session.

An example scenario illustrating the simultaneous provision of multiple interactive sessions is provided herein. This simultaneous provision of multiple interactive sessions may also be referred to as a multi-threaded interactive session. A user may first provide the audible input command “order a pizza” to which the digital assistant responds with the audible output “okay, which toppings would you like on your pizza?” This first interaction is representative of the initiation of a first interactive session associated with a pizza ordering context. Responsive to the digital assistant's output query, a user may provide the audible input “pepperoni”. The digital assistant may then provide a responsive output query such as “okay, would you like any other toppings?” A user may then provide the audible command “dim the lights”. An embodiment may identify that this user command is not associated with the first interactive session, but rather, is representative of a user's intent to initiate a second interactive session associated with a light-dimming context. An embodiment may then perform a function corresponding to the user's command (e.g., an embodiment may dim the lights in the room, etc.).

A user may then provide the audible query “what year was this song released?”, where “this song” refers to a currently playing song. An embodiment may identify that this query is not associated with either the first or the second interactive sessions, but rather, is representative of a user's intent to initiate a third interactive session associated with a song identification context. An embodiment may then process the latest request and provide the output “1995”. A user may then provide the audible input “extra cheese.” An embodiment may identify that this most recent input is most likely associated with the first interactive session, rather than the second or third interactive sessions, and may provide the output “pepperoni and extra cheese, would you like anything else?”. A user may then provide the audible input “go ahead and place the order”. As can be seen, through the course of the above requests, three different conversations associated with different contexts were threaded together (i.e., pizza ordering, song identification, and lighting adjustments) into a conversational session.

The various embodiments described herein thus represent a technical improvement to conventional digital assistant interaction techniques. Using the techniques described herein, an embodiment may identify an interactive session (e.g., either a currently active interactive session or a new interactive session) associated with received user input. An embodiment may then subsequently perform a corresponding function associated with the context of the identified interactive session. Such techniques enable a device to process inputs related to multiple interactive sessions without interrupting or ending any other interactive session.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an indication to begin an interactive session associated with a first context;
receiving, during the interactive session, an indication to begin at least one other interactive session, wherein the at least one other interactive session is associated with another context; and
performing, without ending the interactive session, at least one output function associated with the at least one other interactive session.

2. The method of claim 1, wherein the interactive session comprises receiving at least one user input and performing at least one output function responsive to the at least one user input.

3. The method of claim 1, wherein the at least one other interactive session comprises receiving at least one user input and performing the at least one output function responsive to the at least one user input.

4. The method of claim 1, wherein the first context associated with the interactive session is different than the another context associated with the at least one other interactive session.

5. The method of claim 1, further comprising receiving user input and identifying, using a processor, an interactive session associated with the user input.

6. The method of claim 5, wherein the identifying comprises using a statistical weighting algorithm to identify the interactive session.

7. The method of claim 5, wherein the identifying comprises determining a context associated with the user input.

8. The method of claim 7, further comprising determining whether the determined context is associated with the interactive session or the another interactive session.

9. The method of claim 7, further comprising determining that the determined context comprises a new context that is not associated with the interactive session or the another interactive session.

10. The method of claim 1, further comprising performing, after performing the at least one output function, at least one output function associated with at least one of: the interactive session and another interactive session.

11. An information handling device, comprising:
at least one processor;
a memory device that stores instructions executable by the at least one processor to:
receive an indication to begin an interactive session associated with a first context;
receive, during the interactive session, an indication to begin at least one other interactive session, wherein the at least one other interactive session is associated with another context; and
perform, without ending the interactive session, at least one output function associated with the at least one other interactive session.

12. The information handling device of claim 11, wherein the interactive session comprises instructions executable by the processor to receive at least one user input and perform at least one output function responsive to the at least one user input.

13. The information handling device of claim 11, wherein the at least one interactive session comprises instructions executable by the processor to receive at least one user input and perform the at least one output function responsive to the at least one user input.

14. The information handling device of claim 11, wherein the first context associated with the interactive session is different than the another context associated with the at least one other interactive session.

15. The information handling device of claim 11, wherein the instructions are further executable by the processor to receive user input and identify an interactive session associated with the user input.

16. The information handling device of claim 15, wherein the instructions executable by the processor to identify comprise instructions executable by the processor to use a statistical weighting algorithm to identify the interactive session.

17. The information handling device of claim 15, wherein the instructions executable by the processor to identify comprise instructions executable by the processor to determine a context associated with the user input.

18. The information handling device of claim 17, wherein the instructions are further executable by the processor to determine whether the determined context is associated with the interactive session or the another interactive session.

19. The information handling device of claim 17, wherein the instructions are further executable by the processor to determine that the determined context comprises a new context that is not associated with the interactive session or the another interactive session.

20. A product, comprising:
a storage device that stores code, the code being executable by a processor and comprising:
code that receives an indication to begin an interactive session associated with a first context;
code that receives, during the interactive session, an indication to begin at least one other interactive session, wherein the at least one other interactive session is associated with another context; and
code that performs, without ending the interactive session, at least one output function associated with the at least one other interactive session.
